(19) United States
(12) Patent Application Publication
(10) Pub. No.: US 2025/0370274 A1
(43) Pub. Date: Dec. 4, 2025

(54) VOLUMETRIC DISPLAY AND HEAD-MOUNTED DISPLAY HAVING THE SAME

(71) Applicants: KOREA INSTITUTE OF MACHINERY & MATERIALS, Daejeon (KR); CENTER FOR ADVANCED META-MATERIALS, Daejeon (KR)

(72) Inventors: Hak-Joo LEE, Daejeon (KR); Jae-Hyun KIM, Daejeon (KR); Bongkyun JANG, Daejeon (KR); Mikyung LIM, Daejeon (KR); Hyeon-Don KIM, Daejeon (KR); Minwoo KWEUN, Seoul (KR); Kwangseop KIM, Daejeon (KR)

(21) Appl. No.: 18/681,580

(22) PCT Filed: Nov. 14, 2022
(86) PCT No.: PCT/KR2022/017862

§ 371 Date: Jan. 31, 2025

(30) Foreign Application Priority Data
Dec. 10, 2021 (KR) 10-2021-0176487

(51) Int. Cl. G02B 30/54; G02B 30/31

(52) U.S. Cl. CPC G02B 30/54; G02B 30/31

(57) ABSTRACT

In a volumetric display and a head-mounted display having the volumetric display, the volumetric display includes a plurality of self-luminous display panels and a plurality of shutter panels. The display panels are configured to display an image forwardly, and are spaced apart from each other along a forward and backward direction. Each of the shutter panels is disposed between the self-luminous display panels adjacent to each other. A pixel of the self-luminous display panel corresponds to a pixel of the shutter panel. The shutter panel adjusts transmittance of a light emitted at a plurality of the pixels of the self-luminous display panel which is disposed at a rear side of the shutter panel, for each pixel.

### FIELD OF DISCLOSURE

The present disclosure of invention relates to a volumetric display and a head-mounted display having the volumetric display, and more specifically the present disclosure of invention relates to a volumetric display and a head-mounted display having the volumetric display capable of displaying three-dimensional image much better.

### DESCRIPTION OF RELATED TECHNOLOGY

Generally, a three-dimensional display technology includes glasses-based and glasses-free types.

In the glasses-bases type, an additional accessory like polarized glasses is used for watching a three-dimensional image, and thus it is inconvenient.

As for the glasses-free type, various kinds of displays have been developed, and a light field display, a holographic display, a volumetric display and so on are representative.

Here, the volumetric display has the advantage of being glasses-free, capable of realizing the widest viewing angle, natural accommodation, and high technical feasibility. However, conventionally proposed volumetric technologies have impractical components such as rotating screens, cesium vapor, and airborne plasma generation. For example, swept-volume displays need the rotating screens, static-volume displays needs the cesium vapor, and free-space displays need the airborne plasma generation.

Thus, in addition to the glasses-free characteristics of the volumetric displays, the development of technology that can express images in a more three-dimensional manner is required.

Related prior art is Korean Laid-open Patent No. 10-2007-0006119.

### DETAILED DESCRIPTION OF THE INVENTION

### Technical Purpose

The present invention is developed to solve the above-mentioned problems of the related arts. The present invention provides a volumetric display capable of displaying three-dimensional image much better, by performing the effect of two or more objects naturally overlapping each other.

In addition, the present invention also provides a head-mounted display having the volumetric display.

### Means of Solving Problem

According to an example embodiment, the volumetric display includes a plurality of self-luminous display panels and a plurality of shutter panels. The display panels are configured to display an image forwardly, and are spaced apart from each other along a forward and backward direction. Each of the shutter panels is disposed between the self-luminous display panels adjacent to each other. A pixel of the self-luminous display panel corresponds to a pixel of the shutter panel. The shutter panel adjusts transmittance of a light emitted at a plurality of the pixels of the self-luminous display panel which is disposed at a rear side of the shutter panel, for each pixel.

In an example, the volumetric display may further include a controller. The self-luminous display panel and the shutter panel may be arranged in an order of a first self-luminous display panel, the shutter panel, and a second self-luminous display panel. The controller may be configured to adjust openness of the pixel of the shutter panel corresponding to the pixel of the second self-luminous display panel, to adjust the transmittance of the light emitted from the pixel of the second self-luminous display panel corresponding to the pixel of the first self-luminous display panel, according to On or Off of the pixel of the first self-luminous display panel.

In an example, the controller may close the pixel of the shutter panel corresponding to the pixel of the second self-luminous display panel, to block all light emitted from the pixel of the second self-luminous display panel corresponding to the pixel of the first self-luminous display panel, or the controller may partially open the pixel of the shutter panel corresponding to the pixel of the second self-luminous display panel, to partially transmit the light emitted from the pixel of the second self-luminous display panel, when the first self-luminous display panel is On.

In an example, the controller may completely open the pixel of the shutter panel corresponding to the pixel of the second self-luminous display panel, to transmit all light emitted from the pixel of the second self-luminous display panel corresponding to the pixel of the first self-luminous display panel, when the first self-luminous display panel is Off.

In an example, the shutter panel may include a liquid crystal panel, a first polarizing plate and a second polarizing plate. The first polarizing plate may be disposed at a rear side of the liquid crystal panel and configured to transmit a polarized light along a first direction. The second polarizing plate may be disposed at a front side of the self-luminous display panel disposed at the forefront among the self-luminous display panels, and configured to transmit a polarized light along a second direction substantially perpendicular to the first direction.

In an example, the self-luminous display panel may include a sidewall disposed between the pixels of the self-luminous display panel, to prevent the light emitted from the pixels of the self-luminous display panel from being mixed. The sidewall may make contact with the shutter panel disposed at a front side of the sidewall.

In an example, the volumetric display may further include a condenser lens covering an entire surface of a self-luminous element configured at the pixel of the self-luminous display panel, to emit the light emitted from the self-luminous element as parallel rays.

In an example, the volumetric display may further include a refractive index matching layer filled between the self-luminous display panel and the shutter panel adjacent to each other along the forward and backward direction, and having a refractive index substantially same as that of the self-luminous display panel or the shutter panel. In an example, the volumetric display may further include a hinge connecting the self-luminous display panel with the shutter panel, and configured to be folded and unfolded.

In an example, the volumetric display may further include a position alignment unit configured to align a position of the pixel of the shutter panel corresponding to the pixel of the self-luminous display panel, with the position of the pixel of the self-luminous display panel.

In an example, the position alignment unit may include a magnet material.

According to another example embodiment, a volumetric display includes a plurality of complex panels spaced apart from each other along a forward and backward direction. Each of the complex panel includes a self-luminous display panel configured to display an image forwardly, and a shutter panel disposed at a rear side of the self-luminous display panel. A pixel of the self-luminous display panel corresponds to a pixel of the shutter panel. The shutter panel adjust transmittance of a light emitted at a plurality of the pixels of the self-luminous display panel which is disposed at a rear side of the shutter panel, for each pixel.

In an example, the volumetric display may further include a controller. The complex panels may include a first complex panel and a second complex panel arranged in an order from front to back. The controller may be configured to adjust openness of the pixel of the shutter panel corresponding to the pixel of the self-luminous display panel of the second complex panel, to adjust the transmittance of the light emitted from the pixel of the self-luminous display panel of the second complex panel corresponding to the pixel of the self-luminous display panel of the first complex panel, according to On or Off of the pixel of the self-luminous display panel of the first complex panel.

In an example, the controller may close the pixel of the shutter panel corresponding to the pixel of the self-luminous display panel of the complex panel, to block all light emitted from the pixel of the self-luminous display panel of the second complex panel corresponding to the pixel of the self-luminous display panel of the first complex panel, or the controller may partially open the pixel of the shutter panel corresponding to the pixel of the self-luminous display panel of the second complex panel, to partially transmit the light emitted from the pixel of the self-luminous display panel of the second complex panel, when the self-luminous display panel of the first complex panel is On.

In an example, the controller may completely open the pixel of the shutter panel corresponding to the pixel of the self-luminous display panel of the second complex panel, to transmit all light emitted from the pixel of the self-luminous display panel of the second complex panel corresponding to the pixel of the self-luminous display panel of the first complex panel, when the self-luminous display panel of the first complex panel is Off.

In an example, the shutter panel may include a liquid crystal panel, a first polarizing plate disposed at a rear side of the liquid crystal panel and configured to transmit a polarized light along a first direction, and a second polarizing plate disposed at a front side of the complex display panel disposed at the forefront among the complex display panels, and configured to transmit a polarized light along a second direction substantially perpendicular to the first direction.

In an example, the complex panel may have a base substrate, the shutter panel may be stacked on a surface of the base substrate, and the self-luminous display panel may be stacked on the shutter panel.

In an example, the complex panel may have a base substrate, the self-luminous display panel may be stacked on a first surface of the base substrate, and the shutter panel may be stacked on a second surface of the base substrate.

According to still another example embodiment, a head-mount display includes the volumetric display and a lens disposed between user's eyes and the volumetric display, and configured to provide an image to the user's eyes by magnifying difference in a focal length.

In an example, the volumetric display may extend in a plate shape, may be curved to cover both eyes of the user entirely, or may be curved to cover each eye of the user.

### Effect of Invention

According to the present example embodiments, the pixels of the shutter panel may adjust the transmittance of light emitted from the rear self-luminous element. Each pixel of the shutter panel may be controlled individually, so the transmittance of light emitted from the rear self-luminous element may be adjusted for each pixel. Thus, among the self-luminous elements disposed at the rear, only light emitted from a specific self-luminous element may be emitted to the front or may not be emitted. Then, it may be used to express ambient shadow or ambient light, or to have a rear object visible through a transparent front object, or to have a rear object blurred through a translucent front object. Further, it also performs an occlusion effect in which an object in the back becomes invisible by being obscured by an opaque object in the front.

In addition, the self-luminous display panel and the shutter panel may be manufactured continuously while the hinge portion capable of unfolding and folding is unfolded. Since the above panel manufacturing process may be implemented in a roll-to-roll process, the panel manufacturing process design may be easy and continuous panel manufacturing may be possible.

In addition, in the panel stacking process, which sequentially stacks manufactured panels, the process is easy and simple since the self-luminous display panel and the shutter panel may be stacked by bending the hinge portion.

The effects of the present invention are not limited to the effects described above, and should be understood to include all effects that can be inferred from the configuration of the invention described in the detailed description or claims of the present invention.

### BRIEF DESCRIPTION OF THE DRAWINGS

FIG. 1 is a perspective view illustrating a volumetric display according to an example embodiment of the present invention;

FIG. 2 is a side view illustrating the volumetric display of FIG. 1;

FIG. 3 is a side view illustrating a shutter panel and a second polarizing plate of the volumetric display of FIG. 1;

FIG. 4 is a schematic view illustrating an example operation of a controller and the shutter panel of the volumetric display of FIG. 1;

FIG. 5A and FIG. 5B are example views illustrating image expressions according to the operation of FIG. 4;

FIG. 6 is a schematic view illustrating another example operation of a controller and the shutter panel of the volumetric display of FIG. 1;

FIG. 7 is an example view illustrating an image expression according to the operation of FIG. 6;

FIG. 8 is a side view illustrating a sidewall of the volumetric display of FIG. 1;

FIG. 9 is a side view illustrating a condenser lens of the volumetric display of FIG. 1;

FIG. 10 is a side view illustrating a refractive index matching layer of the volumetric display of FIG. 1;

FIG. 11A and FIG. 11B are process views illustrating a stacking process for the volumetric display of FIG. 1;

FIG. 12 is a side view illustrating a position alignment unit of the volumetric display of FIG. 1;

FIG. 13 is a side view illustrating a volumetric display according to another example embodiment of the present invention;

FIG. 14 is a side view illustrating an example complex panel of the volumetric display of FIG. 13;

FIG. 15 is a side view illustrating another example complex panel of the volumetric display of FIG. 13;

FIG. 16A and FIG. 16B are schematic views illustrating an operation of a controller and a shutter panel of the volumetric display of FIG. 13;

FIG. 17 is a side view illustrating a sidewall of the volumetric display of FIG. 13;

FIG. 18 is a side view illustrating a condenser lens of the volumetric display of FIG. 13;

FIG. 19 is a side view illustrating a refractive index matching layer of the volumetric display of FIG. 13;

FIG. 20A and FIG. 20B are processing views illustrating a stacking process and a position alignment unit of volumetric display of FIG. 13; and

FIG. 21A, FIG. 21B and FIG. 21C are schematic views illustrating the volumetric display of FIG. 1 or FIG. 13 applied to a head-mounted display.

* Reference numerals

| | |
|---|---|
| 1, 2, 3: head-mounted display | 10, 20: volumetric display |
| 100: self-luminous display panel | 101: pixel |
| 110: base substrate | 120: self-luminous element |
| 200: shutter panel | 201: pixel |
| 210: liquid crystal panel | 240: first polarizing plate |
| 300: second polarizing plate | 400, 1400: controller |
| 500, 1500: sidewall | 550, 1550: condenser lens |
| 600, 1600: refractive index matching layer | 700, 1700: hinge |
| 800, 1800: position alignment unit | 1000: complex panel |
| 1100: self-luminous display panel | 1200: self-luminous element |
| 1200: shutter panel | 1220: liquid crystal panel |

### DETAILED DESCRIPTION

The invention is described more fully hereinafter with Reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention is described more fully hereinafter with reference to the accompanying drawings, in which embodiments of the invention are shown.

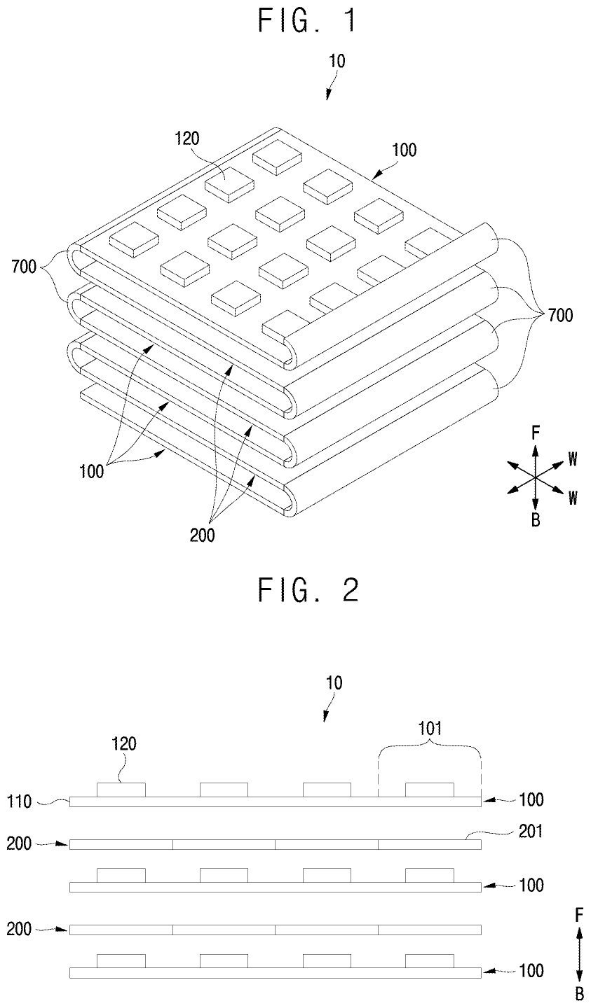

FIG. 1 is a perspective view illustrating a volumetric display according to an example embodiment of the present invention. FIG. 2 is a side view illustrating the volumetric display of FIG. 1.

Referring to FIG. 1 and FIG. 2, the volumetric display 10 includes a self-luminous display panel 100 and a shutter panel 200.

The self-luminous display panel 100 includes a base substrate 110, and a plurality of self-luminous elements 120 mounted on the base substrate 110. The self-luminous element 120 is an element receiving a current and emitting the light, and for example, may be a light emitting diode (LED).

The self-luminous display panel 100 is plural, and the plurality of the self-luminous display panel 100 is spaced apart from each other along a forward and backward direction. The self-luminous element 120 of each of the self-luminous display panel 100 may be disposed to face the forward F, and thus the self-luminous display panel 100 may display a two-dimensional image to the forward F.

The shutter panel 200 is disposed between the self-luminous display panels adjacent to each other. Thus, from the forward F to the backward B, the self-luminous display panel 100 and the shutter panel 200 are disposed repeatedly and alternately.

Accordingly, in the volumetric display 10 according to the present example embodiment, the self-luminous display panel 100 and the shutter panel 200 are alternately stacked with each other.

The self-luminous display panel 100 may have a pixel 101 corresponding to each of the self-luminous element 120, and the shutter panel 200 may have a pixel 201 corresponding to the pixel of the self-luminous display panel 100. Here, the pixel 101 may be disposed or arranged in a line with the pixel 201 along the forward and backward direction. The pixel 101 of the self-luminous display panel 100 may overlap with the pixel 201 of the shutter panel 200 along the forward direction F or the backward direction B.

The pixel 201 of the shutter panel 200 may adjust the transmittance of the light emitted from the self-luminous element 120 of the self-luminous display panel 100 disposed at a rear side of the shutter panel 200. Here, the pixels 201 of the shutter panels 200 may be controlled individually, and then the transmittance of the light emitted from the self-luminous elements 120 of the rear side self-luminous display panels 100, individually for each pixel.

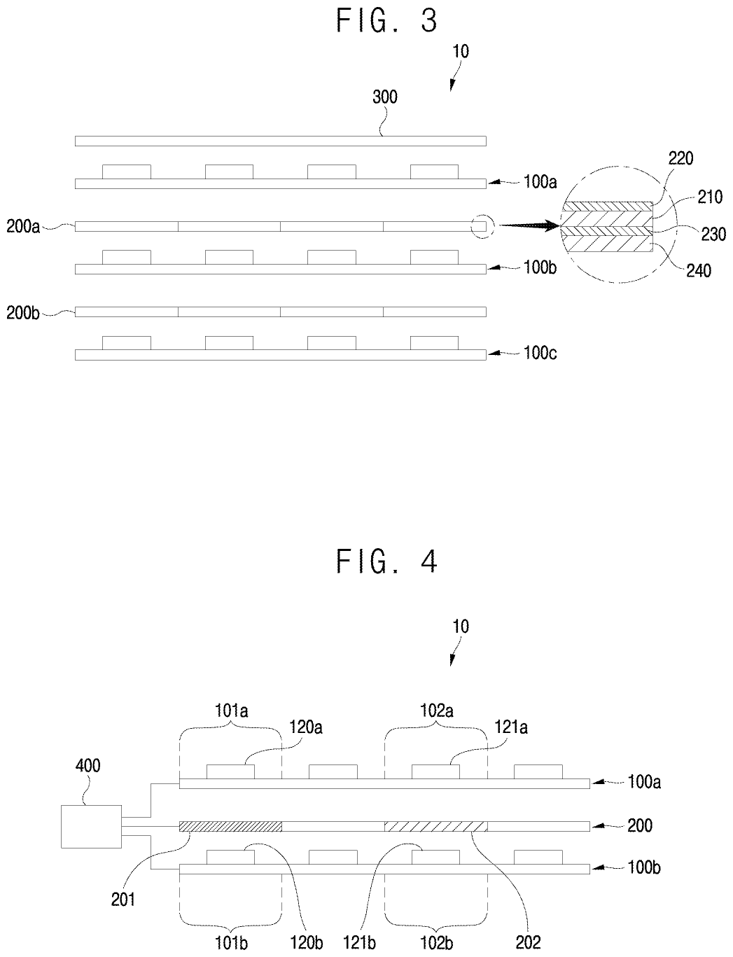

FIG. 3 is a side view illustrating a shutter panel and a second polarizing plate of the volumetric display of FIG. 1.

Hereinafter, the forward and the backward mean the forward direction F and the backward direction B of FIG. 1 and FIG. 2, respectively.

Referring to FIG. 3, the shutter panel includes a liquid crystal panel 210, a first electrode 220, a second electrode 230 and a first polarizing plate 240.

The first electrode 220 is a transparent electrode disposed at a front side of the liquid crystal panel 210, and the second electrode 230 is a transparent electrode disposed at a rear side of the liquid crystal panel 210.

The first polarizing plate 240 is disposed at the rear side of the liquid crystal panel 210, and transmits a polarizing light along a first direction. The first polarizing plate 240 transmits the polarizing light along the first direction and blocks the polarizing light along a second direction substantially perpendicular to the first direction, among the lights emitted from the self-luminous display panel disposed at the rear side of the shutter panel.

The volumetric display 10 may further include a second polarizing plate 300.

The second polarizing plate 300 is disposed at the front side of the self-luminous display panel 100a which is disposed at the forefront among the self-luminous display panels. The second polarizing plate 300 transmits the polarizing light along the second direction.

Thus, the first polarizing light of the light emitted forwardly from the self-luminous display panel 100c disposed at the rearmost position passes through the shutter panels 200b and 200a at the front side. The first polarizing light of the light emitted forwardly from the self-luminous display panel 100b disposed at a central position passes through the shutter panel 200a at the front side. However, the first polarizing light may be blocked by the second polarizing plate 300.

The second polarizing light of the light emitted forwardly from the self-luminous display panel 100a disposed at the foremost position passes through the second polarizing plate 300.

The liquid crystal panel 210 controls the polarizing direction by the applied voltage, and thus the amount of the light passing through the first and second polarizing plates 240 and 300 may be controlled linearly. Accordingly, the shutter panel may completely block the light emitted from the backward to the forward, may partially block or may completely pass the light. Thus, the shutter panel may control the amount of the light emitted from the backward to the forward.

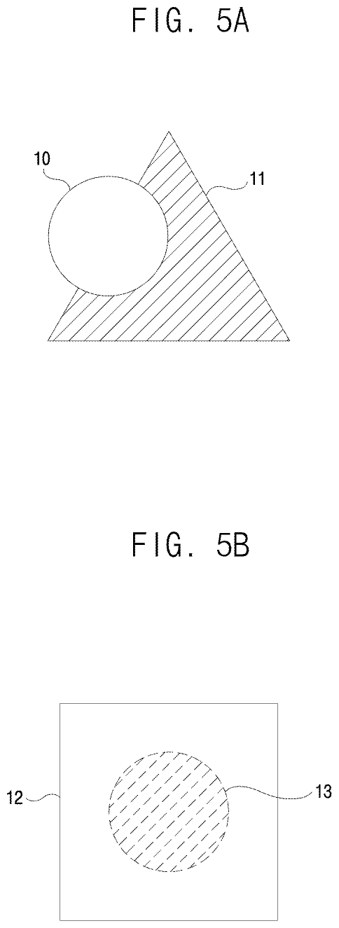

FIG. 4 is a schematic view illustrating an example operation of a controller and the shutter panel of the volumetric display of FIG. 1. FIG. 5A and FIG. 5B are example views illustrating image expressions according to the operation of FIG. 4.

Hereinafter, it will be explained that the first self-luminous display panel 100a, the shutter panel 200, and the second self-luminous display panel 100b are arranged in that order from the front to the rear.

Referring to FIG. 4 and FIG. 5, the volumetric display 10 further includes a controller 400.

The controller 400 adjusts openness of the pixel of the shutter panel corresponding to the pixel of the second self-luminous display panel 100b, to adjust the transmittance of the light emitted from the pixel of the second self-luminous display panel 100b corresponding to the pixel of the first self-luminous display panel 100a, according to On (light on) or Off (light off) of the pixel of the first self-luminous display panel 100a.

For example, the controller 400 closes the pixel of the shutter panel 200 corresponding to (or overlapping with) the pixel of the second self-luminous display panel 100b, to block all light emitted from the pixel of the second self-luminous display panel 100b corresponding to (or overlapping with) the pixel of the first self-luminous display panel 100a, or the controller 400 partially opens the pixel of the shutter panel 200 corresponding to the pixel of the second self-luminous display panel 100b, to partially transmit the light emitted from the pixel of the second self-luminous display panel 100b, when the first self-luminous display panel 100a is On.

As illustrated in FIG. 4, the controller 400 closes the first pixel 201 of the shutter panel 200 corresponding to first self-luminous element 120b, to block all light emitted from the first self-luminous element 120b of the first pixel 101b corresponding to (or overlapping with) the first self-luminous element 120a of the second self-luminous display panel 100b, when the first self-luminous element 120a of the first pixel 101a of the first self-luminous display panel 100a is On.

Then, the light emitted from the first self-luminous element 120b of the second self-luminous display panel 100b disposed at the rear side is blocked by the first pixel 201 of the shutter panel 200, and then is not emitted toward the front of the first self-luminous display panel 100a. Thus, as illustrated in FIG. 5A, when displaying the image at which two objects 10 and 11 are overlapped, the portion blocked by the front object 10 displayed by the front self-luminous element among the rear object 11 displayed by the rear self-luminous element is not displayed. That is, an occlusion effect may be implemented in which the rear object becomes invisible by being obscured by the opaque front object.

Alternatively, the controller 400 partially opens the second pixel 202 of the shutter panel 200 corresponding to the second self-luminous element 121b, to partially transmit the light emitted from the second self-luminous element 121b of the second pixel 102b corresponding to the first self-luminous element 121a in the second self-luminous display panel 100b, when the first self-luminous element 121a of the second pixel 102a in the first self-luminous display panel 100a is On.

Then, the light emitted from the second self-luminous element 121b of the second self-luminous display panel 100b disposed at the rear side partially passes through the second pixel 202 of the shutter panel 200, and then is emitted toward the front of the first self-luminous display panel 100a. Thus, as illustrated in FIG. 5B, when displaying the image at which two objects 12 and 13 are overlapped, the rear object 13 is displayed through the front object 12 when the front object 12 has a transparent material, or the rear object 13 is displayed blurry through the front object 12 when the front object 12 has a translucent material.

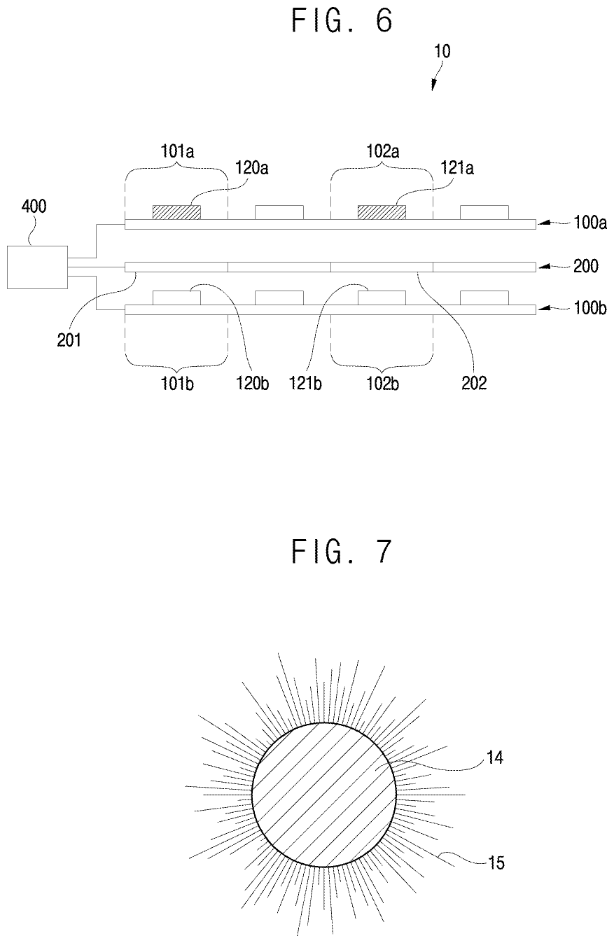

FIG. 6 is a schematic view illustrating another example operation of a controller and the shutter panel of the volumetric display of FIG. 1. FIG. 7 is an example view illustrating an image expression according to the operation of FIG. 6.

Referring to FIG. 6, the controller 400 completely opens the pixel of the shutter panel 200 corresponding to the pixel of the second self-luminous display panel, to transmit all light emitted from the pixel of the second self-luminous display panel 100b corresponding to the pixel of the first self-luminous display panel 100a, when the first self-luminous display panel 100a is Off.

As illustrated in FIG. 6, the controller 400 completely opens the first pixel 201 of the shutter panel 200 corresponding to the first self-luminous element 120b and the second pixel 202 of the shutter panel 200 corresponding to the second self-luminous element 121b, to transmit all light emitted from the first self-luminous element 120b corresponding to the first self-luminous element 120a and all light from the second self-luminous element 121b corresponding to the second self-luminous element 121a in the second self-luminous display panel 100b, when the first self-luminous element 120a of the first pixel 101a and the second self-luminous element 121a of the second pixel 102a in the first self-luminous display panel 100a are Off.

Accordingly, the light emitted from the first self-luminous element 120b and the second self-luminous element 121b of the second self-luminous display panel 100b disposed at the rear side passes through the first pixel 201 and the second pixel 202 of the shutter panel 200, and then is emitted toward the front of the first self-luminous display panel 100a. Thus, as illustrated in FIG. 7, an ambient shadow or an ambient light 15 may be displayed by the light shining from the rear to the front than the front object 14.

Here, if the shadow created by light emitted from a light source such as the sun is called as Shadow, the ambient Shadow may refer to a weaker shadow created when a light source is scattered by surrounding objects. In addition, the ambient light may refer to indirect light that does not come directly from a light source among the light projected on an object, but reaches it by being reflected by another object.

As described above, the volumetric display 10 according to the present example embodiment may effectively implement not only a shielding effect in which two or more objects naturally overlap each other, but also expressions of the ambient Shadow or the ambient light, thereby providing a more natural and realistic three-dimensional image may be expressed.

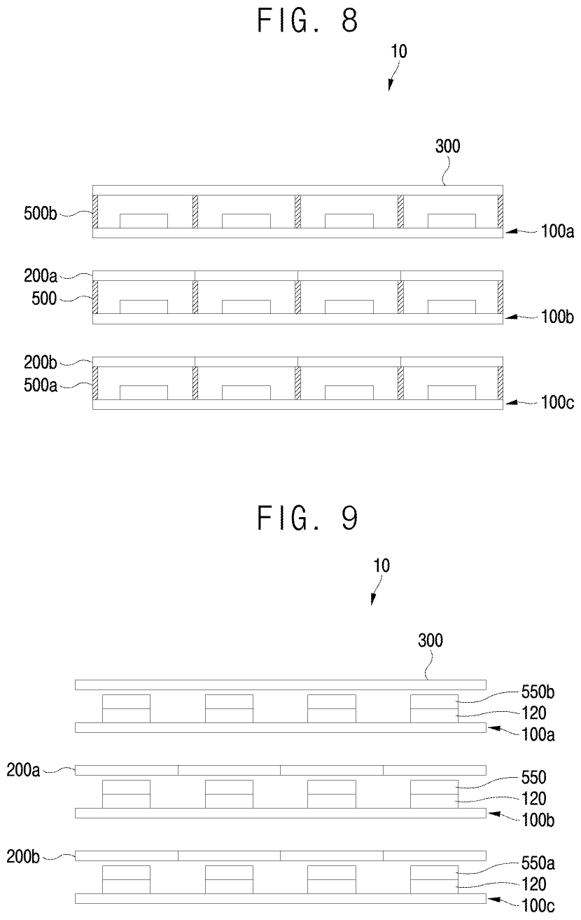

FIG. 8 is a side view illustrating a sidewall of the volumetric display of FIG. 1.

Referring to FIG. 8, the self-luminous display panel further includes a sidewall.

The sidewall is disposed between the pixels of the self-luminous display panel adjacent to each other. The sidewall makes contact with the shutter panel disposed at the front of the sidewall, and prevents the light emitted from the pixels of the self-luminous display panel from being mixed.

The sidewall 500a of the self-luminous display panel 100c disposed at the rearmost side makes contact with the shutter panel 200b right in front, and the sidewall 500 of the self-luminous display panel 100b disposed at the center makes contact with the shutter panel 200a right in front, so that the light emitted from each pixel is prevented from being incident into other pixel and then the light emitted from each pixel is prevented from being mixed.

The sidewall 500b of the self-luminous display panel 100a disposed at the foremost side makes contact with the second polarizing plate 300.

FIG. 9 is a side view illustrating a condenser lens of the volumetric display of FIG. 1.

Referring to FIG. 9, the volumetric display 10 includes condenser lenses 550, 550a and 550b.

The condenser lenses 550, 550a and 550b are disposed at the front side of the self-luminous element 120, and cover an entire surface of the self-luminous element 120. Each of the condenser lenses 550, 550a and 550b has an area substantially same as that of the self-luminous element 120. The condenser lenses 550, 550a and 550b send out the light emitted from the self-luminous element 120 as parallel rays. The condenser lenses 550, 550a and 550b may allow light output in the vertical direction to be greater than that in other directions, and thus the condenser lenses 550, 550a and 550b may achieve the effect of making the image displayed on the volumetric display 10 appear clear rather than blurry. Each of the condenser lenses 550, 550a and 550b may be Fresnel lens.

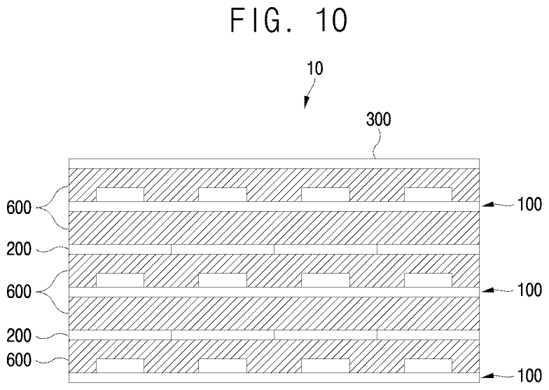

FIG. 10 is a side view illustrating a refractive index matching layer of the volumetric display of FIG. 1.

Referring to FIG. 10, the volumetric display 10 includes a refractive index matching layer 600.

The refractive index matching layer 600 is filled between the self-luminous display panel 100 and the shutter panel 200 adjacent to each other along the forward and backward direction. The refractive index matching layer 600 may have the refractive index substantially same as that of the self-luminous display panel 100 or that of the shutter panel 200. The refractive index matching layer 600 decreases the light unnecessarily reflected on the surface of the display panel 100 and the shutter panel 200, and then more clear and bright image may be displayed.

The refractive index matching layer 600 may be filled between the self-luminous display panel 100 disposed at the foremost side and the second polarizing plate 300.

Although not shown in the figure, as explained in FIG. 8, with the sidewall 500a being formed between the pixels adjacent to each other, the refractive index matching layer 600 may be filled between the self-luminous display panel 100 and the shutter panel 200 additionally.

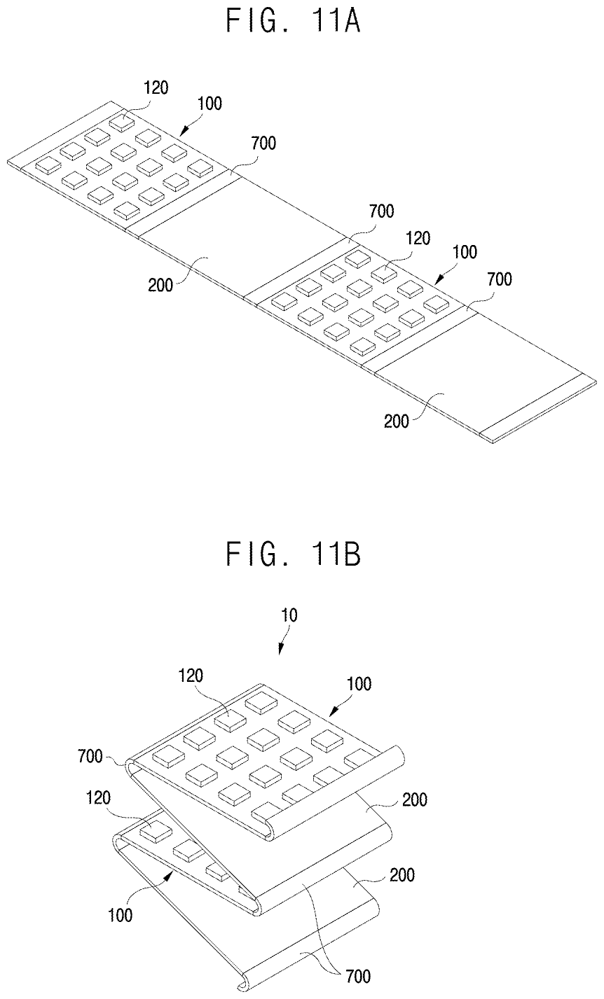

FIG. 11A and FIG. 11B are process views illustrating a stacking process for the volumetric display of FIG. 1.

Referring to FIG. 1, FIG. 11A and FIG. 11B, the volumetric display 10 further includes a hinge 700.

The hinge 700 connects the self-luminous display panel 100 with the shutter panel 200, and may be formed to be folded and unfolded.

Referring to FIG. 11A, in manufacturing the panel, a plurality of functional layers is stacked on the base substrate and the self-luminous element 120 is mounted, and then the self-luminous display panel 100 is manufactured. The electrode and the polarizing plate are stacked on the liquid crystal panel, and then the shutter panel 200 is manufactured. Here, the hinge 700 is unfolded, and the self-luminous element 120 of the self-luminous display panel 100 and the shutter panel 200 are disposed along a direction. The above manufacturing process may be performed by a roll-to-roll process, and the process design for the panel manufacturing may be easy and the manufacturing efficiency may be increased. The panel in which a thin-film transistor (TFT) for an active driving may be formed in the base substrate or the liquid crystal panel, and the technology to implement the active driving by forming the TFT on the display substrate may use already commercialized TFT LCD technology or AMOLED technology.

In addition, referring to FIG. 11B, in the panel stacking process in which the panels are sequentially stacked, the hinge 700 is folded and then the self-luminous element 120 of the self-luminous display panel 100 and the shutter panel 200 are stacked to be in one direction. The panel stacking process may be performed immediately by folding only the hinge 700 while the panel is manufactured, so the process may be easy and simple.

A plurality of the stacked volumetric displays may be disposed in a width direction (W), and thus the volumetric display may be manufactured with a relatively larger area.

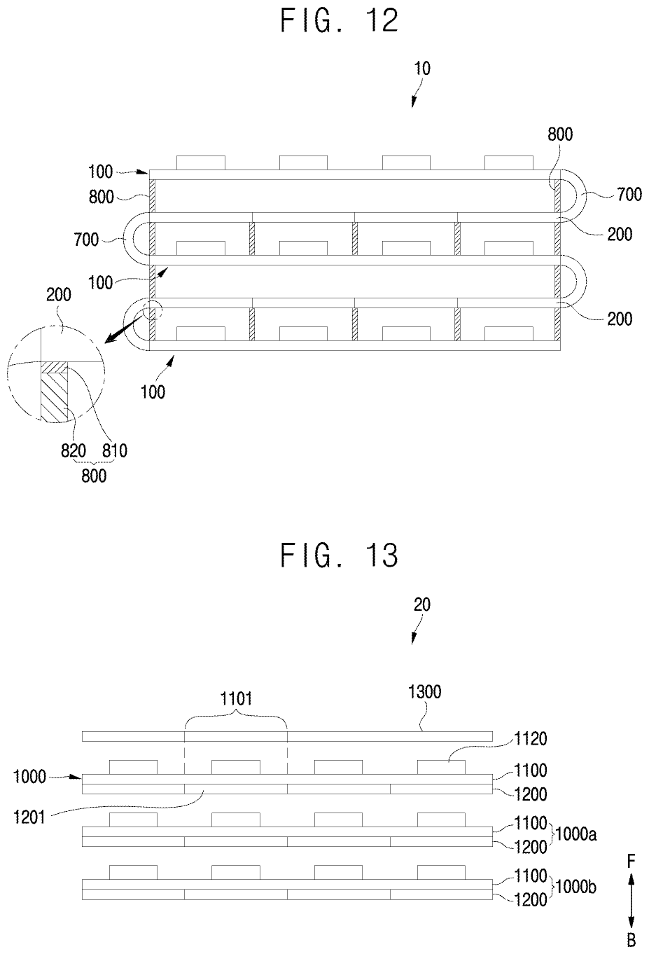

FIG. 12 is a side view illustrating a position alignment unit of the volumetric display of FIG. 1.

Referring to FIG. 12, the volumetric display 10 further includes a position alignment unit 800.

The position alignment unit 800 includes a magnet 810 and an alignment bar 820.

The magnet 810 is disposed at a rear surface of the self-luminous display panel 100, and the alignment bar 820 is disposed at a front surface of the shutter panel 200. The alignment bar 820 may include a metal material and may be attached to or detached from the magnet 810.

In the above panel stacking process, when the alignment bar 820 is attached to the magnet 810, the pixel of the self-luminous display panel 100 and the pixel of the shutter panel 200 corresponding to the pixel of the self-luminous display panel 100 may be confirmed with each other.

The position alignment unit 800 is not limited to being provided separately as shown in FIG. 12. The sidewall 500 explained in FIG. 8 may include the metal material functioned as the alignment bar 820, and the magnet is formed on the rear surface of the self-luminous display panel 100, so that the sidewall 500 is attached to the magnet 810 and the light mixing may be prevented and the position may be aligned.

FIG. 13 is a side view illustrating a volumetric display according to another example embodiment of the present invention.

The volumetric display 20 according to the present example embodiment is substantially same as the volumetric display 10 of FIG. 1 except that the self-luminous display panel and the shutter panel are formed in the same substrate, and any repetitive explanation will be omitted.

Referring to FIG. 13, the volumetric display 20 according to the present example embodiment includes a plurality of complex panels 1000, 1000a and 1000b which is spaced apart from each other along the forward and backward direction.

The complex panel has the self-luminous display panel 1100 and the shutter panel 1200.

The self-luminous display panel 1100 displays the 2-dimensional image to the front, and the shutter panel 1200 is disposed at the rear side of the self-luminous display panel 1100.

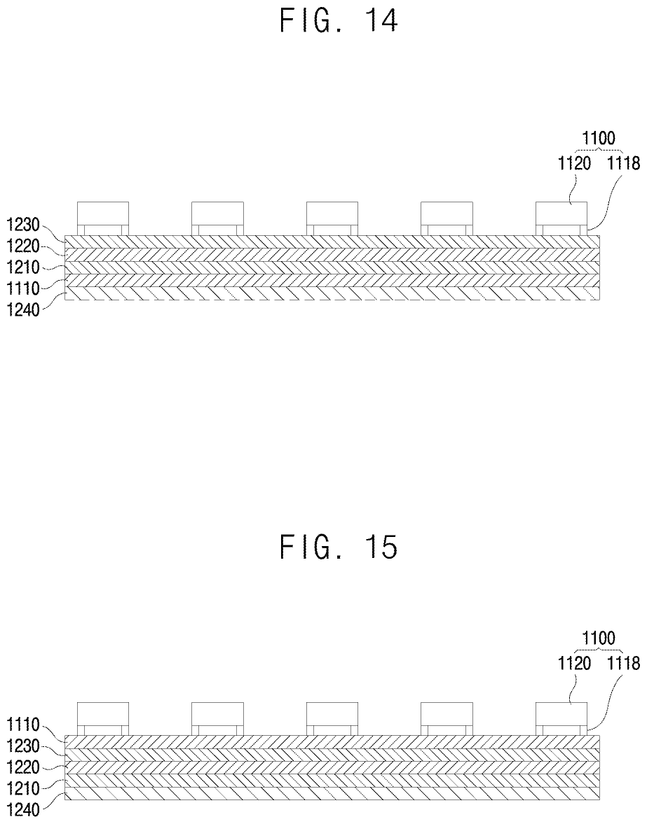

FIG. 14 is a side view illustrating an example complex panel of the volumetric display of FIG. 13.

Referring to FIG. 14, the complex panel has a base substrate 1110.

In addition, the shutter panel 1200 (referring to FIG. 13) is formed on the base substrate 1110.

The shutter panel 1200 has a first electrode 1210 formed on an upper surface of the base substrate 1110, a liquid crystal panel 1220 formed on an upper surface of the first electrode 1210, and a second electrode 1230 formed on an upper surface of the liquid crystal panel 1220.

The base substrate 1110 in itself is formed to pass through the polarizing light along the first direction. When the base substrate 1110 is not formed to pass through the polarizing light along the first direction, the first polarizing plate 1240 passing through the polarizing light along the first direction may be further disposed on a lower surface of the base substrate 1110.

The self-luminous display panel 1100 is formed on the shutter panel 1200. The self-luminous display panel 1100 has an electric contact portion 1118 and a self-luminous element 1120, and the electric contact portion 1118 may have a solder, a metal bump or an anisotropic conductive film. The electric contact portion 1118 is formed directly on the second electrode 1230, and the self-luminous element 1120 electrically makes contact with the substrate through the electric contact portion 1118.

Alternatively, the self-luminous display panel and the shutter panel may be disposed or formed in other pattern or shape.

FIG. 15 is a side view illustrating another example complex panel of the volumetric display of FIG. 13. Referring to FIG. 15, the self-luminous display panel 1100 is formed on the upper surface of the base substrate 1110, and the shutter panel 1200 (referring to FIG. 13) is formed on the lower surface of the base substrate 1110.

Here, the second electrode 1230 of the shutter panel 1200 is formed on the lower surface of the base substrate 1110, the liquid crystal panel 1220 is formed on the lower surface of the second electrode 1230, and the first electrode 1210 is formed on the lower surface of the liquid crystal panel 1220. Here, the first polarizing plate 1240 is formed on the lower surface of the first electrode 1210.

Referring to FIG. 13 again, the second polarizing plate 1300 is formed at a front side of the foremost complex panel 1000.

The liquid crystal panel 1220 controls the polarizing direction due to the applied voltage, and thus the amount of the light passing through the first and second polarizing plates 1240 and 1300 is gradually controlled. Thus, each shutter panel 1200 completely blocks the light emitted toward the front side, partially blocks the light emitted toward the front side or controls the amount of the light emitted toward the front side without blocking the light.

In the present example embodiment, the self-luminous display panel 1100 has a pixel 1101 corresponding to each self-luminous element 1120, and the shutter panel 1200 has a pixel 1201 corresponding to the pixel 1101 of the self-luminous display panel 1100.

In addition, the pixel 1201 of the shutter panel 1200 is individually controlled, and the transmittance of the light emitted from the self-luminous element 1120 of the rear self-luminous display panel 1100 is controlled for each pixel.

In addition, the volumetric display 20 according to the present example embodiment further includes a controller 1400. The controller 1400 adjusts openness of the pixel of the shutter panel 1200 corresponding to the pixel of the self-luminous display panel of the second complex panel, to adjust the transmittance of the light emitted from the pixel of the self-luminous display panel of the second complex panel corresponding to the pixel of the self-luminous display panel of the first complex panel, according to On or Off of the pixel of the self-luminous display panel of the first complex panel.

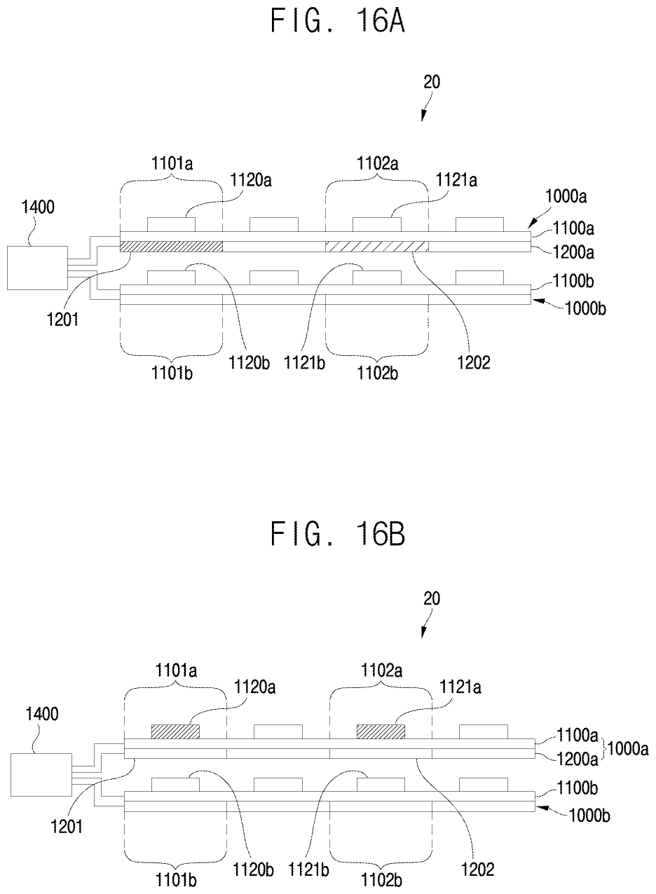

FIG. 16A and FIG. 16B are schematic views illustrating an operation of a controller and a shutter panel of the volumetric display of FIG. 13.

First, referring to FIG. 16A, the controller 1400 closes the first pixel 1201 of the shutter panel 1200a corresponding to the first self-luminous element 1120b, to block all light emitted from the self-luminous element 1120b of the first pixel 1101b corresponding to the first self-luminous element 1120a in the self-luminous display panel 1100b of the second complex panel 1000b, when the first self-luminous element 1120a of the first pixel 1101a in the self-luminous display panel 1100a of the first complex panel 1000a is On. Thus, the effect of making the part of the rear object obscured by the front object invisible may be implemented.

In addition, the controller 1400 partially opens the second pixel 1202 of the shutter panel 1200a corresponding to the second self-luminous element 1121b, to partially transmit the light emitted from the second self-luminous element 1121b of the second pixel 1120b corresponding to the second self-luminous element 1121a in the self-luminous display panel 1100b of the second complex panel 1000b, when the second self-luminous element 1121a of the second pixel 1102a in the self-luminous display panel 1100a of the first complex panel 1000a is On. Thus, an effect may be implemented in which a rear object is visible through a transparent front object, or a rear object is visible blurred through a translucent front object.

In addition, referring to FIG. 16B, the controller 1400 completely opens the first pixel 1201 of the shutter panel 1200a corresponding to the first self-luminous element 1120b and the second pixel 1201 of the shutter panel 1200a corresponding to the second self-luminous element 1121b, to transmit all light emitted from the first self-luminous element 1120b corresponding to the first self-luminous element 1120a in the self-luminous display panel 1100b of the second complex panel 1000b, and to transmit all light emitted from the second self-luminous element 1121b corresponding to the second self-luminous element 1121a in the self-luminous display panel 1100b of the second complex panel 1000b, when the first self-luminous element 1120a of the first pixel 1101a and the second self-luminous element 1121a of the second pixel 1102a in the self-luminous display panel 1100a of the first complex panel 1000a is Off. Thus, expression of ambient shadow or ambient light (15) may be possible.

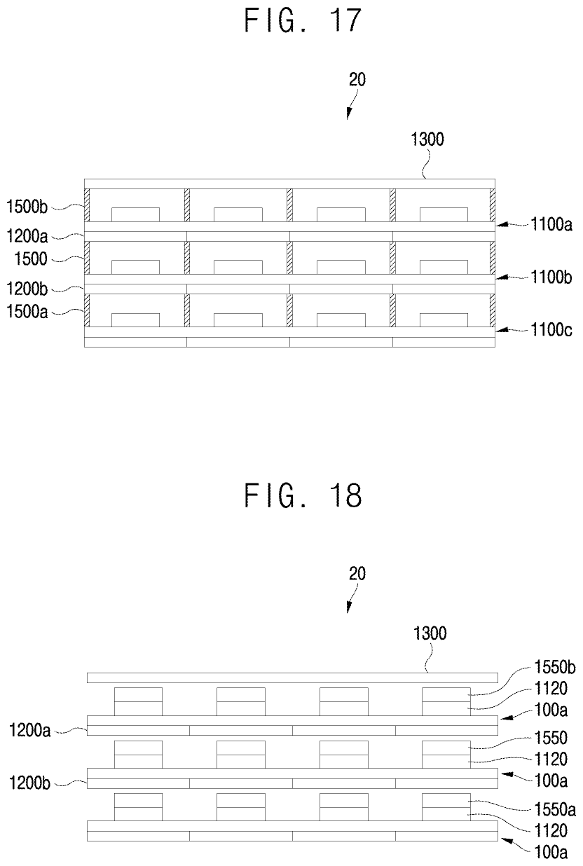

FIG. 17 is a side view illustrating a sidewall of the volumetric display of FIG. 13.

Referring to FIG. 17, in the present example embodiment, the self-luminous display panels 1000a, 1000b and 1000c respectively have sidewalls 1500, 1500a and 1500b disposed between the pixels of the self-luminous display panel adjacent to each other, to prevent the light emitted from the pixels of the self-luminous display panel from being mixed. Each of the sidewalls 1500 and 1500a makes contact with each of the shutter panels 1200a and 1200b disposed at the front side of the sidewalls. The sidewall 1500b of the self-luminous display panel 1100a at the foremost makes contact with the second polarizing plate 1300.

FIG. 18 is a side view illustrating a condenser lens of the volumetric display of FIG. 13.

Referring to FIG. 18, the volumetric display 20 includes condenser lenses 1550, 1550a and 1550b.

Each of the condenser lenses 1550, 1550a and 1550b is disposed at the front side of the self-luminous element 1120, and covers the entire surface of the self-luminous element 1120. Each of the condenser lenses 1550, 1550a and 1550b sends out the light emitted from the self-luminous element 1120 as parallel rays. The condenser lenses 1550, 1550a and 1550b may allow the amount of the light emitted in the vertical direction to be greater than that in other directions. Thus, it is possible to achieve the effect of making the image displayed on the volumetric display 20 appear clear rather than blurry. Each of the condenser lenses 1550, 1550a and 1550b may be a Fresnel lens.

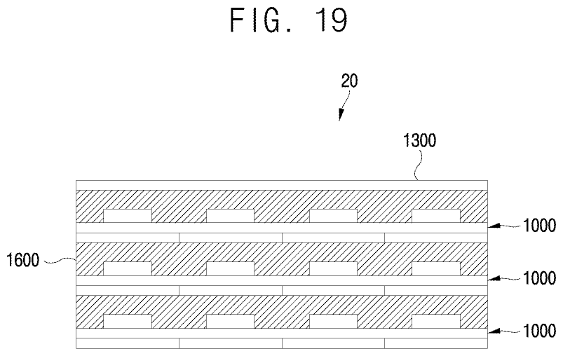

FIG. 19 is a side view illustrating a refractive index matching layer of the volumetric display of FIG. 13.

Referring to FIG. 19, the volumetric display 20 according to the present example embodiment includes a refractive index matching layer 1600.

The refractive index matching layer 1600 is filled between the complex panels 1000 adjacent to each other along the forward and backward direction. The refractive index matching layer 1600 may have the refractive index substantially same as that of the complex panel 1000. The refractive index matching layer 1600 may be filled between the complex panel 1000 at the foremost and the second polarizing plate 1300.

Further, as explained above, the refractive index matching layer 1600 may be filled between the complex panels 1000 adjacent to each other along the forward and backward direction, with the sidewalls 1500, 1500a and 1500b being disposed between the pixels of the self-luminous display panel adjacent to each other as in FIG. 17.

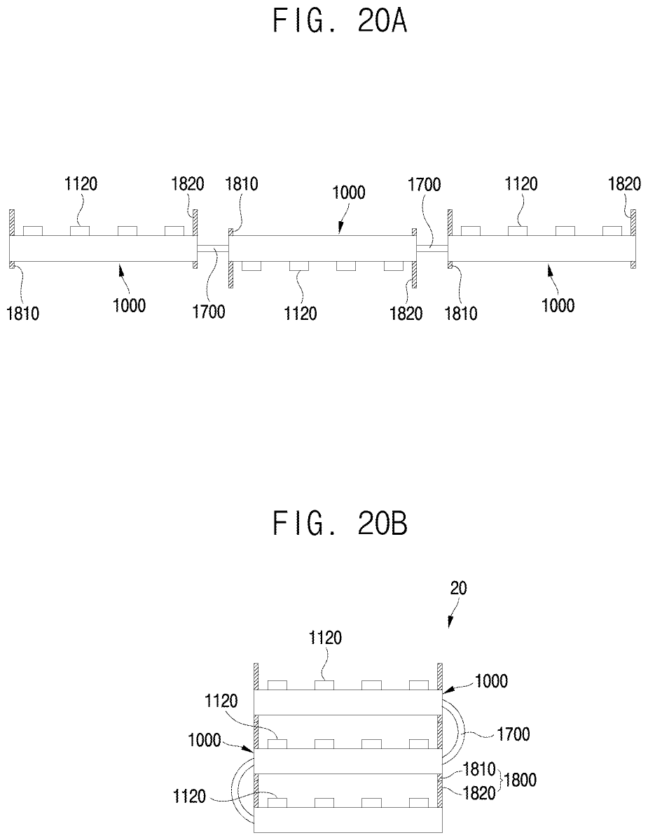

FIG. 20A and FIG. 20B are processing views illustrating a stacking process and a position alignment unit of volumetric display of FIG. 13.

Referring to FIG. 20A and FIG. 20B, the volumetric display 20 further includes a hinge 1700. The hinge 1700 connects the complex panels 1000 with each other, and may be folded and unfolded.

As in FIG. 20A, in manufacturing the complex panel 1000, the hinge 1700 is unfolded and the complex panels 1000 are alternately disposed with each other to be in an opposite direction. At the complex panels 1000, the mounted self-luminous elements 1120 adjacent to each other face in opposite directions.

Thus, as illustrated in FIG. 20b, in the panel stacking process in which the manufactured panels are sequentially stacked, the hinge 1700 is unfolded and thus the self-luminous elements 1200 of the complex panels 1000 are stacked to face in one direction.

The volumetric display 20 further includes a position alignment unit 1800.

The position alignment unit 1800 includes a magnet 1810 and an alignment bar 1820.

The magnet 1810 is disposed at a rear side of the complex panel 1000 and the alignment bar 1820 is disposed at a front side of the complex panel 1000. In the panel stacking process, when the alignment bar 1820 is attached to the magnet 1810, the positions of the pixels of the self-luminous display panel 1100 are aligned with each other.

In the present example embodiment, the alignment bar 1820 of the position alignment unit 1800 may be substituted as the sidewall 1500.

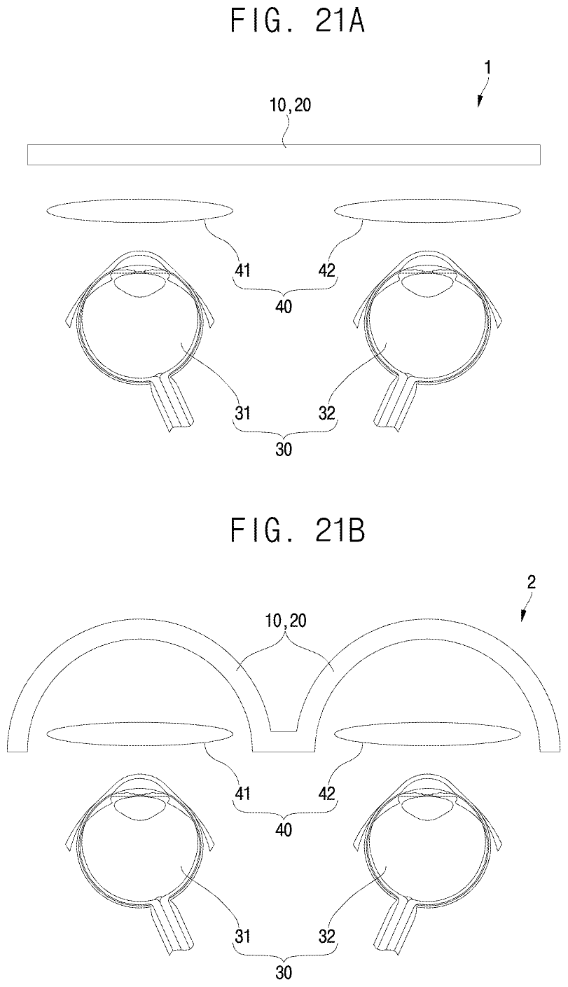

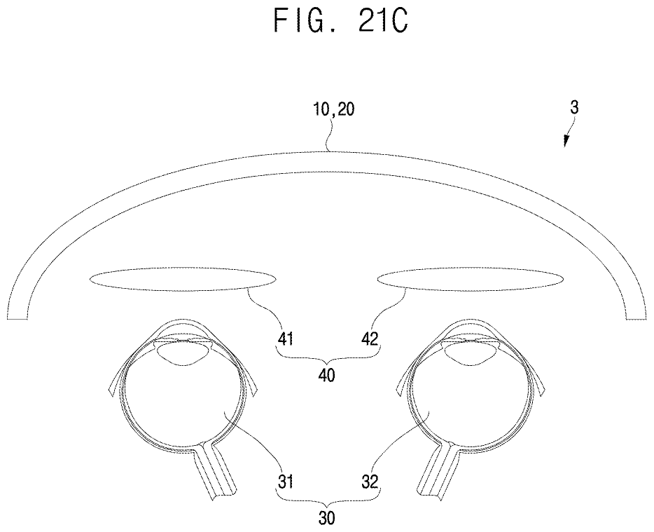

FIG. 21A, FIG. 21B and FIG. 21C are schematic views illustrating the volumetric display of FIG. 1 or FIG. 13 applied to a head-mounted display.

First, referring to FIG. 21A, the volumetric display 10 and 20 of FIG. 1 and FIG. 13 may be applied to the display at the head-mounted display (HMD) 1.

Generally, in the head-mounted display, when viewing images such as virtual reality or augmented reality, it is very important to resolve VAC (vergence accommodation conflict), that is the discomfort that occurs when the actual location of the object does not match the location of the object perceived by the person's eyes and brain. However, when using a conventional varifocal lens or a lens capable of changing the optical path, it is difficult to secure a wide viewing angle and the volume of the optical system increases.

Thus, as in FIG. 21A, by arranging the volumetric displays 10 and 20 in front of the user's eyes 30, the optical system may be simplified while varying the focal distance.

In this case, a lens 40 may be additionally provided between the volumetric display 10 and 20 and the user's eyes 30 to magnify the difference in focal length and provide an image to the user's eyes 30, and the lens 40 may include a left lens 41 and a right lens 42 respectively disposed on the left eye 31 and the right eye 32.

As in FIG. 21B, the volumetric display 10 and 20 may be manufactured as curved displays that are bent into a hemispherical or round shape to match the structure of each eye 31 and 32.

Alternatively, as in FIG. 21C, the volumetric displays 10 and 20 may be manufactured as curved displays that cover the entire user's eyes 30 and are curved in a round shape.

Through the curved volumetric display as shown in FIG. 21B and FIG. 21C, the viewing angle may be increased compared to a flat volumetric display.

Furthermore, the volumetric display 10 and 20 described through the present example embodiments may be applied as displays for displaying images on various types of head mounted displays in addition to the head mounted displays 1, 2 and 3 of the shape or the structure illustrated above.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. For example, each component described as unitary may be implemented in a distributed manner, and similarly, components described as distributed may also be implemented in a combined form. The scope of the present invention is indicated by the claims described below, and all changes or modified forms derived from the meaning and scope of the claims and their equivalent concepts should be construed as being included in the scope of the present invention.

1. A volumetric display comprising:
a plurality of self-luminous display panels configured to display an image forwardly, and spaced apart from each other along a forward and backward direction; and
a plurality of shutter panels, each of the shutter panels being disposed between the self-luminous display panels adjacent to each other,
wherein a pixel of the self-luminous display panel corresponds to a pixel of the shutter panel,
wherein the shutter panel adjusts transmittance of a light emitted at a plurality of the pixels of the self-luminous display panel which is disposed at a rear side of the shutter panel, for each pixel.

2. The volumetric display of claim 1, further comprising a controller,
wherein the self-luminous display panel and the shutter panel are arranged in an order of a first self-luminous display panel, the shutter panel, and a second self-luminous display panel,
wherein the controller configured to adjust openness of the pixel of the shutter panel corresponding to the pixel of the second self-luminous display panel, to adjust the transmittance of the light emitted from the pixel of the second self-luminous display panel corresponding to the pixel of the first self-luminous display panel, according to On or Off of the pixel of the first self-luminous display panel.

3. The volumetric display of claim 2, wherein the controller closes the pixel of the shutter panel corresponding to the pixel of the second self-luminous display panel, to block all light emitted from the pixel of the second self-luminous display panel corresponding to the pixel of the first self-luminous display panel, or
the controller partially opens the pixel of the shutter panel corresponding to the pixel of the second self-luminous display panel, to partially transmit the light emitted from the pixel of the second self-luminous display panel,
when the first self-luminous display panel is On.

4. The volumetric display of claim 2, wherein the controller completely opens the pixel of the shutter panel corresponding to the pixel of the second self-luminous display panel, to transmit all light emitted from the pixel of the second self-luminous display panel corresponding to the pixel of the first self-luminous display panel,
when the first self-luminous display panel is Off.

5. The volumetric display of claim 1, wherein the shutter panel comprises:
a liquid crystal panel;
a first polarizing plate disposed at a rear side of the liquid crystal panel and configured to transmit a polarized light along a first direction; and
a second polarizing plate disposed at a front side of the self-luminous display panel disposed at the forefront among the self-luminous display panels, and configured to transmit a polarized light along a second direction substantially perpendicular to the first direction.

6. The volumetric display of claim 1, wherein the self-luminous display panel comprises a sidewall disposed between the pixels of the self-luminous display panel, to prevent the light emitted from the pixels of the self-luminous display panel from being mixed,
wherein the sidewall makes contact with the shutter panel disposed at a front side of the sidewall.

7. The volumetric display of claim 1, further comprising:
a condenser lens covering an entire surface of a self-luminous element configured at the pixel of the self-luminous display panel, to emit the light emitted from the self-luminous element as parallel rays.

8. The volumetric display of claim 1, further comprising:
a refractive index matching layer filled between the self-luminous display panel and the shutter panel adjacent to each other along the forward and backward direction, and having a refractive index substantially same as that of the self-luminous display panel or the shutter panel.

9. The volumetric display of claim 1, further comprising:
a hinge connecting the self-luminous display panel with the shutter panel, and configured to be folded and unfolded.

10. The volumetric display of claim 1, further comprising:
a position alignment unit configured to align a position of the pixel of the shutter panel corresponding to the pixel of the self-luminous display panel, with the position of the pixel of the self-luminous display panel.

11. The volumetric display of claim 10, wherein the position alignment unit comprises a magnet material.

12. A volumetric display comprises:
a plurality of complex panels spaced apart from each other along a forward and backward direction,
wherein each of the complex panel comprises:
a self-luminous display panel configured to display an image forwardly; and
a shutter panel disposed at a rear side of the self-luminous display panel,
wherein a pixel of the self-luminous display panel corresponds to a pixel of the shutter panel,
wherein the shutter panel adjusts transmittance of a light emitted at a plurality of the pixels of the self-luminous display panel which is disposed at a rear side of the shutter panel, for each pixel.

13. The volumetric display of claim 12, further comprising a controller,
wherein the complex panels comprises a first complex panel and a second complex panel arranged in an order from front to back,
wherein the controller configured to adjust openness of the pixel of the shutter panel corresponding to the pixel of the self-luminous display panel of the second complex panel, to adjust the transmittance of the light emitted from the pixel of the self-luminous display panel of the second complex panel corresponding to the pixel of the self-luminous display panel of the first complex panel, according to On or Off of the pixel of the self-luminous display panel of the first complex panel.

14. The volumetric display of claim 13, wherein the controller closes the pixel of the shutter panel corresponding to the pixel of the self-luminous display panel of the complex panel, to block all light emitted from the pixel of the self-luminous display panel of the second complex panel corresponding to the pixel of the self-luminous display panel of the first complex panel, or
the controller partially opens the pixel of the shutter panel corresponding to the pixel of the self-luminous display panel of the second complex panel, to partially transmit the light emitted from the pixel of the self-luminous display panel of the second complex panel,
when the self-luminous display panel of the first complex panel is On.

15. The volumetric display of claim 13, wherein the controller completely opens the pixel of the shutter panel corresponding to the pixel of the self-luminous display panel of the second complex panel, to transmit all light emitted from the pixel of the self-luminous display panel of the second complex panel corresponding to the pixel of the self-luminous display panel of the first complex panel,
when the self-luminous display panel of the first complex panel is Off.

16. The volumetric display of claim 12, wherein the shutter panel comprises:
a liquid crystal panel;
a first polarizing plate disposed at a rear side of the liquid crystal panel and configured to transmit a polarized light along a first direction; and
a second polarizing plate disposed at a front side of the complex display panel disposed at the forefront among the complex display panels, and configured to transmit a polarized light along a second direction substantially perpendicular to the first direction.

17. The volumetric display of claim 12, wherein the complex panel has a base substrate, the shutter panel is stacked on a surface of the base substrate, and the self-luminous display panel is stacked on the shutter panel.

18. The volumetric display of claim 12, wherein the complex panel has a base substrate, the self-luminous display panel is stacked on a first surface of the base substrate, and the shutter panel is stacked on a second surface of the base substrate.

19. A head-mounted display comprises:
the volumetric display of claim 1; and
a lens disposed between user's eyes and the volumetric display, and configured to provide an image to the user's eyes by magnifying difference in a focal length.

20. The head-mounted display of claim 19, wherein the volumetric display extends in a plate shape, is curved to cover both eyes of the user entirely, or is curved to cover each eye of the user.
